(19) United States
(12) Patent Application Publication
(10) Pub. No.: US 2020/0383513 A1
(43) Pub. Date: Dec. 10, 2020

(54) IMMERSION COFFEE OR TEA BREWING SYSTEM AND METHOD FOR CUPPING

(71) Applicant: TODDY, LLC, Loveland, CO (US)

(72) Inventors: Julia Leach, Denver, CO (US); Scott Borger, Centennial, CO (US); Clint Kolda, Loveland, CO (US); Matthew Irish, Wellington, CO (US)

(21) Appl. No.: 16/892,249

(22) Filed: Jun. 3, 2020

Related U.S. Application Data
(60) Provisional application No. 62/857,246, filed on Jun. 4, 2019.

(51) Int. Cl. A47J 31/06; A47J 31/44

(52) U.S. Cl. CPC A47J 31/0615; A47J 31/4407

(57) ABSTRACT

An immersion coffee or tea brewing (ICB) system is disclosed. The ICB system comprises a brewing vessel having a top and a filter basket. The brewing vessel is configured to receive a closeable filter having coffee or tea within the brewing vessel and water. The filter basket is configured to be removably attached to the top of the brewing vessel, hold the closeable filter, and drain the closeable filter into the brewing vessel.

### CLAIM OF PRIORITY

This application claims priority to U.S. Provisional Patent Application Ser. No. 62/857,246, titled “System and Method For Cupping Cold Brew Coffee,” filed on Jun. 4, 2019 under 35 U.S.C. 119(e), which is herein incorporated by reference in its entirety.

### BACKGROUND

### 1. Field

The present disclosure is related to systems and methods for brewing coffee.

### 2. Related Art

At present, cold coffee brewing, also known as cold brewing, immersion brewing, cold water extraction or cold pressing, is the process of steeping coffee grounds in water at cool or ambient/room temperatures for an extended period. Ground coffee beans are soaked in water for a prolonged period of time. After soaking, the coffee grounds are filtered out of the water after they have been steeped using, for example, a paper filter, a fine metal sieve, a French press, or felt, in the case of the brewing system. The result is a coffee concentrate that is diluted prior to consumption with water or milk, and is served hot, over ice, or blended with ice and other ingredients such as, for example, chocolate. Unfortunately, known techniques for cold brewing coffee do not usually translate to a different scale. Coffee brewed in small batch brewers does not taste the same as the same coffee brewed in larger batch brewers, since the brewer designs result in different extractions.

Coffee cupping is a technique used for analyzing the sensory characteristics of hot brewed coffee. It is a professional practice performed by coffee buyers, judges, enthusiasts, and professionals alike. Coffee cupping is frequently used by producers and buyers around the world to check the quality or flavor profile of a particular batch of coffee. In cupping, coffees are scored for aspects such as fragrance, aroma, flavor, acidity, body, mouthfeel, uniformity, balance, cleanness, sweetness, and aftertaste. Cupping is also used to identify defects present in coffee and to assess coffee blends. Furthermore, cupping is also used a method to determine preferences between different coffees and brewing parameters.

A standard coffee cupping procedure generally involves deeply sniffing the coffee, then quickly slurping the coffee so it spreads to the back of the tongue and across the palette. The coffee taster attempts to assess aspects of the coffee's taste, body (the texture or mouthfeel, such as oiliness), sweetness, acidity (a sharp and tangy feeling, like when biting into an orange), flavor, and aftertaste.

Because the ground coffee beans in cold brewed coffee never come into contact with heated water, the process of extracting flavor from the beans produces a chemical profile different from conventional brewing methods. Coffee beans contain a number of constituent parts that are more soluble at higher temperatures, such as caffeine, oils and fatty acids. Brewing at a lower temperature results in lower acidity and lower caffeine content when brewed in equal volume. It is around 65 to 70 percent less acidic than hot drip coffee or espresso, per part. Unfortunately, while coffee cupping is well known in relation to hot brewed coffee, at present there is no equivalent procedure or supporting product for cold brewed coffee.

As such, there is a need for an immersion coffee brewing system that addresses these issues.

### SUMMARY

Disclosed is an immersion coffee or tea brewing (ICB) system. The ICB system comprises a brewing vessel having a top and a filter basket. The brewing vessel is configured to receive a closeable filter having coffee or tea within the brewing vessel and water. The filter basket is configured to be removably attached to the top of the brewing vessel, hold the closeable filter, and drain the closeable filter into the brewing vessel.

The ICB system may also include a lid configured to be removably attached to the top of the brewing vessel prior to removably attaching the filter basket and seal the brewing vessel to prevent off-gassing from the immersion of the coffee or tea in the water. The lid may include an off-gassing opening and may be configured to be rotated along the top of the brewing vessel from a sealed position that prevents off-gassing to an open position that allows off-gassing through the off-gassing opening. The brewing vessel may include a spout at the top of the brewing vessel where the spout is configured to allow off-gassing when the lid is rotated to the open position and the off-gassing opening of the lid is positioned adjacent the spout of the brewing vessel.

The ICB system may also include the closeable filter, where the closeable filter is a filter bag having an open top configured to receive the coffee or tea and the water. The closeable filter may be further configured to be partially sealed by twisting the open top to a closed position after receiving the coffee or tea and water. Moreover, the closeable filter may be constructed from a material that allows the closeable filter to be steeped in a coffee solution or tea solution for an extended period of time, lifted from the brewing vessel after being filled with coffee or tea and immersed in the coffee solution or tea solution, respectively, for the extended period of time, and placed on the filter basket to drain the coffee solution or tea solution from the closeable filter to the brewing vessel. In this example, the coffee solution is created by the coffee and the water and the filter basket may include draining holes at a bottom of the filter basket. The tea solution is created by the tea and water.

In an example, of operation, the ICB may perform a method that includes inserting the closeable filter into the brewing vessel, inserting coffee or tea into the closeable filter, and pouring water into the closeable filter. The method may also include partially sealing the closeable filter, steeping the closeable filter within the water in the brewing vessel for the extended period of time, and removing the closeable filter from the brewing vessel; and draining the closeable filter into the brewing vessel.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1A is a front perspective view of an example of an implementation of the ICB system in accordance with the present disclosure.

FIG. 1B is another front perspective view of the ICB system, shown in FIG. 1A, in accordance with the present disclosure.

FIG. 2 is another front perspective view of the ICB system, shown in FIGS. 1A and 1B, in accordance with the present disclosure.

FIG. 3A a front-perspective view of the brewing vessel is shown where the brewing vessel is constructed with a transparent material that allows the volume markings to be visible in accordance with the present disclosure.

FIG. 3B is a top view of the brewing vessel in accordance with the present disclosure.

FIG. 3C is a side-view of the brewing vessel in accordance with the present disclosure.

FIG. 4A is a top-perspective view of an example of an implementation of the filter basket shown in FIGS. 1A-2 in accordance with the present disclosure.

FIG. 4B is bottom-perspective view of the filter basket shown in FIG. 4A in accordance with the present disclosure.

FIG. 4C is a top view of the filter basket shown in FIG. 4A-4B in accordance with the present disclosure.

FIG. 4D is a bottom view of the filter basket shown in FIG. 4A-4C in accordance with the present disclosure.

FIG. 4E is a side-view of the filter basket shown in FIG. 4A-4D in accordance with the present disclosure.

FIG. 5A is a top-perspective view of an example of another implementation of the filter basket shown in FIG. 1A-2 in accordance with the present disclosure.

FIG. 5B is a bottom perspective view of the filter basket shown in FIG. 5A in accordance with the present disclosure.

FIG. 6A is a top-perspective view of an example of an implementation of the basket guard shown in FIGS. 1A-2 and 4A-5B in accordance with the present disclosure.

FIG. 6B is a side-view of the basket guard shown in FIGS. 1A-2, 4A-5B, and 6A in accordance with the present disclosure.

FIG. 7A is a top view of an example of an implementation of the lid shown in FIGS. 1A-2 in accordance with the present disclosure.

FIG. 7B is a bottom view of the lid shown in FIGS. 1A-2 and 7A in accordance with the present disclosure.

FIG. 7C is a front view of the lid shown in FIGS. 1A-2 and 7A-7B in accordance with the present disclosure.

FIG. 7D is a side-view of the lid shown in FIGS. 1A-2 and 7A-7C in accordance with the present disclosure.

FIG. 8A is a top-perspective view of an example of an implementation of a combination of the brewing vessel and filter basket shown in FIGS. 1A-4E in accordance with the present disclosure.

FIG. 8B is a side-view of an example of the combination of the brewing vessel and filter basket shown in FIGS. 1A-4E and 6A in accordance with the present disclosure.

FIG. 9A is a side-perspective view of an example of an implementation of the brewing vessel with a closeable filter shown in FIGS. 1A-2 in accordance with the present disclosure.

FIG. 9B is a side-perspective view of the brewing vessel with the closeable filter receiving ground coffee in accordance with the present disclosure.

FIG. 9C is a side-perspective view of the brewing vessel with the closeable filter receiving water in accordance with the present disclosure.

FIG. 9D is a side-perspective view of the brewing vessel with the closeable filter and lid in accordance with the present disclosure.

FIG. 9E is a side-perspective view of the brewing vessel with the closeable filter being removed in accordance with the present disclosure.

FIG. 9F is a side-view of the combination of the brewing vessel and filter basket with the closeable filter being placed within the filter basket in accordance with the present disclosure.

FIG. 9G is a side-view of the combination of the brewing vessel after the filter basket and closeable filter have been removed in accordance with the present disclosure.

FIG. 10 is a flowchart of an example of an implementation of a general method for immersion coffee brewing in accordance with the present disclosure.

FIG. 11 is a flowchart of an example of an implementation of a specific method for cupping a cold brew coffee in accordance with the present disclosure.

### DETAILED DESCRIPTION

An immersion coffee or tea brewing (ICB) system is disclosed. The ICB system comprises a brewing vessel having a top and a filter basket. The brewing vessel is configured to receive a closeable filter having coffee or tea within the brewing vessel and water. The filter basket is configured to be removably attached to the top of the brewing vessel, hold the closeable filter, and drain the closeable filter into the brewing vessel.

The ICB system may also include a lid configured to be removably attached to the top of the brewing vessel prior to removably attaching the filter basket and seal the brewing vessel to prevent off-gassing from the immersion of the coffee or tea in the water. The lid may include an off-gassing opening and may be configured to be rotated along the top of the brewing vessel from a sealed position that prevents off-gassing to an open position that allows off-gassing through the off-gassing opening. The brewing vessel may include a spout at the top of the brewing vessel where the spout is configured to allow off-gassing when the lid is rotated to the open position and the off-gassing opening of the lid is positioned adjacent the spout of the brewing vessel.

The ICB system may also include the closeable filter, where the closeable filter is a filter bag having an open top configured to receive the coffee or tea and the water. The closeable filter may be further configured to be partially sealed by twisting the open top to a closed position after receiving the coffee or tea and water. Moreover, the closeable filter may be constructed from a material that allows the closeable filter to be steeped in a coffee solution or tea solution for an extended period of time, lifted from the brewing vessel after being filled with coffee or tea and immersed in the coffee solution or tea solution for the extended period of time, and placed on the filter basket to drain the coffee solution or tea solution from the closeable filter to the brewing vessel. In this example, the coffee solution is created by the coffee and the water and the filter basket may include draining holes at a bottom of the filter basket. The tea solution is created by the tea and the water.

In an example of operation, the ICB may perform a method that includes inserting the closeable filter into the brewing vessel, inserting coffee or tea into the closeable filter, and pouring water into the closeable filter. The method may also include partially sealing the closeable filter, steeping the closeable filter within the water in the brewing vessel for the extended period of time, and removing the closeable filter from the brewing vessel; and draining the closeable filter into the brewing vessel.

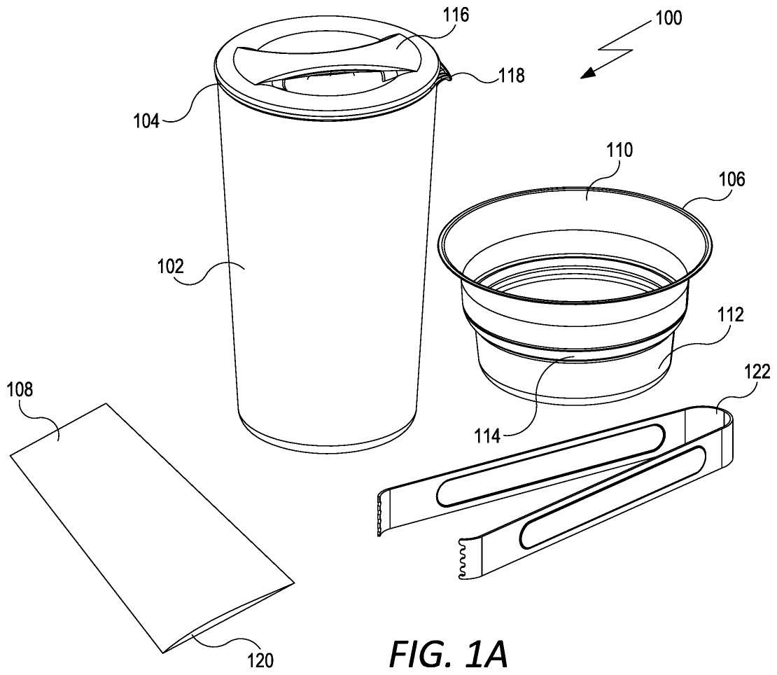

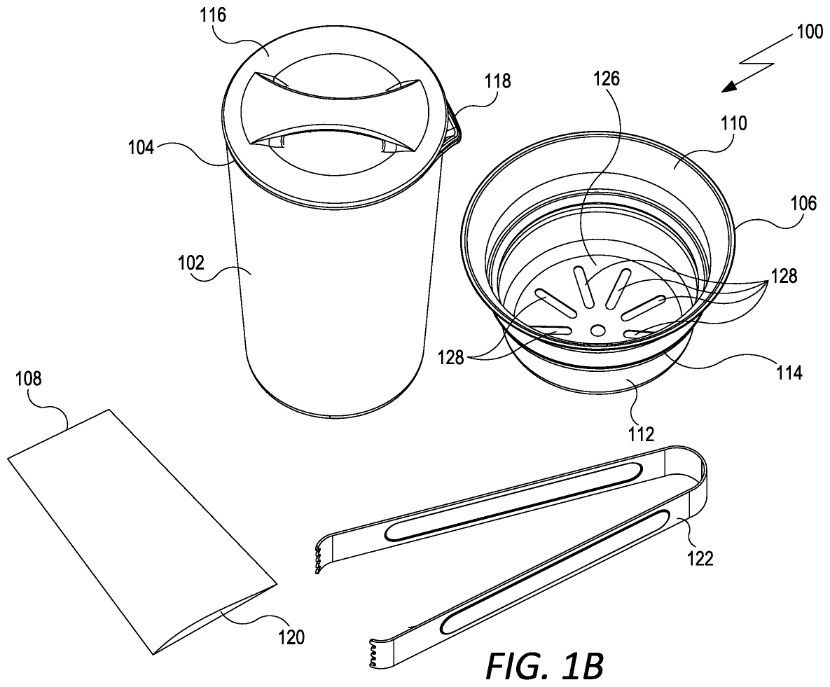

Turning to FIG. 1A, a front perspective view of an example of an implementation of the ICB system 100 is shown in accordance with the present disclosure. In this example, the ICB system 100 includes a brewing vessel 102 having a top 104 (i.e., a rim) and a filter basket 106. The brewing vessel 102 is configured to receive a closeable filter 108 having coffee within the brewing vessel 102 and water and be placed on the top 104 of the brewing vessel 102. The filter basket 106 is configured to be removably attached to the top 104 of the brewing vessel 102, hold the closeable filter 108, and drain the closeable filter 108 into the brewing vessel 102. In this example, the filter basket 106 may include a top portion 110 and a lower portion 112, where the top portion 110 is designed and configured to receive and hold the closeable filter 108 when the closeable filter 108 is draining a coffee solution or tea solution that is created by the coffee or tea and the water. The lower portion 112 of the filter basket 106 is designed and configured to be inserted into the top portion of the cavity within the brewing vessel 102 through the top 104 of the brewing vessel 102. As a result, the lower portion 112 may have an outer diameter that is slightly less than the inner diameter of the top portion of cavity within the brewing vessel 102 and the top portion 110 may have an outer diameter that is greater than the outer diameter of the top 104 of the brewing vessel 102. As an example, the outer diameter of the lower portion 112 of the filter basket 106 may be chosen so as to mechanically seal the top 104 of the brewing vessel 102 or as bumper to prevent damaging the glass of the brewing vessel 102. The filter basket 106 may also include a basket guard 114 that is configured to hold the filter basket 106 on top of the brewing vessel 102.

In this example, the ICB system 100 may also include a lid 116 configured to be removably attached to the top 104 of the brewing vessel 102 prior to removably attaching the filter basket 106. The lid 116 is configured to cap the top of the brewing vessel 102 for storage after brewing and to seal the brewing vessel 102 to prevent outside elements, flavors, etc. for entering and impacting the taste of brewed coffee or tea concentrate in brewing vessel 102. The lid 116 also prevents off-gassing from the immersion of the coffee or tea in the water. The lid 116 may include an off-gassing opening (i.e., a vent) and may be configured to rotate along the top 104 of the brewing vessel 102 from a sealed position for storage or that prevents off-gassing to an open position that allows serving via the vent and spout 118 or off-gassing through the off-gassing opening. The brewing vessel 102 may include a spout 118 at the top 104 of the brewing vessel 102 where the spout 118 is configured to allow off-gassing when the lid 116 is rotated to the open position and the off-gassing opening of the lid 116 is positioned adjacent the spout 118 of the brewing vessel 102. The spout 118 may also be a graduated spout that is designed for accurate and easily controllable pouring of the resulting brewed coffee or tea from the brewing vessel 102.

In this example, the closeable filter 108 is shown as being an empty porous filter bag having an open top 120 configured to receive the coffee or tea and the water once the closeable filter 108 is inserted into the cavity of the brewing vessel 102. In this example, the closeable filter 108 is configured to be partially sealed by twisting the open top 120 to a closed position after receiving the coffee or tea and water (within the brewing vessel 102). The open top 120 may also be optionally tied with a string or a silicone clamp or the closeable filter 108 may also include an optional drawstring. The closeable filter 108 is constructed from a porous material that allows the closeable filter to be steeped in the coffee solution or tea solution for an extended period of time, lifted from the brewing vessel 102 after being filled with coffee or tea and immersed in the coffee solution or tea solution for the extended period of time, and placed on and within the top portion 110 of the filter basket 106 to drain the coffee solution or tea solution from the closeable filter 108 to the brewing vessel 102.

The ICB system 100 may also include a pair of tongs 122. The tongs 122 are utilized to place and remove the closeable filter 108 from the cavity inside of the brewing vessel 102 and the basket guard 114 is configured to hold the filter basket 106 on top 104 of the brewing vessel 102.

In FIG. 1B, another front perspective view of the ICB system 100 is shown in accordance with the present disclosure. In this example, the filter basket 106 is shown having a bottom surface 126. The filter basket 106 includes a plurality of draining holes 128 at the bottom surface 126. The draining holes 128 may have varying types of openings in the bottom surface 126, which may include, for example, round holes, elliptical holes, slits, or other geometric shaped holes. From this view, the filter basket 106 may feature an oversized, rounded rim that guides the closeable filter 108 into place for draining (i.e., dripping). The filter basket 106 may also feature an angled bottom for the bottom surface 126 that aids in efficient draining and the basket guard 114 (that may be a gasket constructed of silicone) for soft contact with the top 104 (i.e., rim) of the brewing vessel 102. The filter basket 106 may also optionally include feet (not shown) for free-standing.

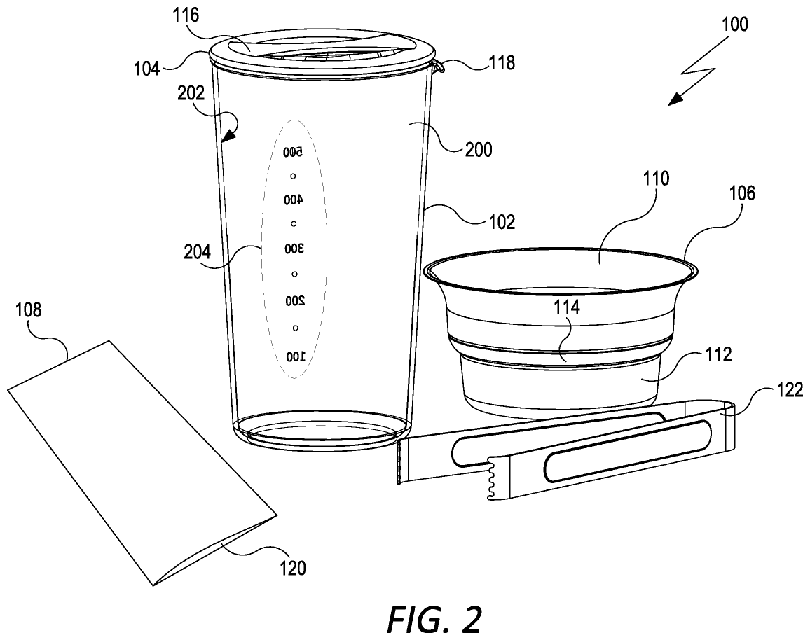

In FIG. 2, yet another front perspective view of the ICB system 100 is shown in accordance with the present disclosure. In this view, the brewing vessel 102 is shown as being constructed of a transparent material. The brewing vessel 102 may be made, for example, from high quality borosilicate glass for optimal clarity, cleanability, corrosion resistance, longevity, and no impact on flavor on the brewed coffee or tea. In this view, the cavity 200 of the brewing vessel 102 is shown. An inner surface 202 of the cavity 200 is also shown within the brewing vessel 102. The outer diameter of the lower portion 112 of the filter basket 106 is configured to be removably attached to the inner surface 202 of the brewing vessel 102 at the top portion of the brewing vessel 102.

Alternatively, the brewing vessel 102 may be made, for example, from a ceramic material, stainless steel, or other suitable material.

In this example, the brewing vessel 102 includes volume markings 204 which in combination with the overall volume of the brewing vessel 102 is designed to support several brewing ratios for the brewed coffee or tea. In this example, the volume markings 204 may be baked on to the brewing vessel 102 (that may be made of glass) for extreme scratch resistance and durability.

In these examples, all the parts of the ICB system 100 may be constructed from durable, food safe, and dishwasher safe materials. For example, the filter basket 106 and tongs 122 may be constructed from food grade 304 stainless steel. The lid 116 and basket guard 114 may be constructed from soft silicone for optimal fit, feel and durability. All the parts may be sized and shaped for single hand operation to aid fluid and efficient movement throughout brewing and/or cupping process and may have compact footprints and stackable parts for space-efficient storage.

Furthermore, in these examples, the lid 116 can be rotated along the top 104 of the brewing vessel 102 to either a sealed position that prevents off-gassing to an open position that allows off-gassing through the off-gassing opening. The lid 116 may also be configured to be drip catcher for the filter basket 106 when the wet closeable filter 108 is placed within the filter basket 106. The tongs 122 may include reinforced arms and gently angled ends with rounded teeth for easily gripping the closeable filter 108 while minimizing the puncture potential of puncturing the closeable filter 108.

The ICB system 100 may be designed with high resolution branding, neutral colors, ergonomic curves, clean edges, and form-fit components. The filter basket 106 and tongs 122 may be made from matching stainless steel and the lid 116 and basket guard 114 may be made from matching silicone. The closeable filter 108 that may be filled with ground coffee beans through the open top 120.

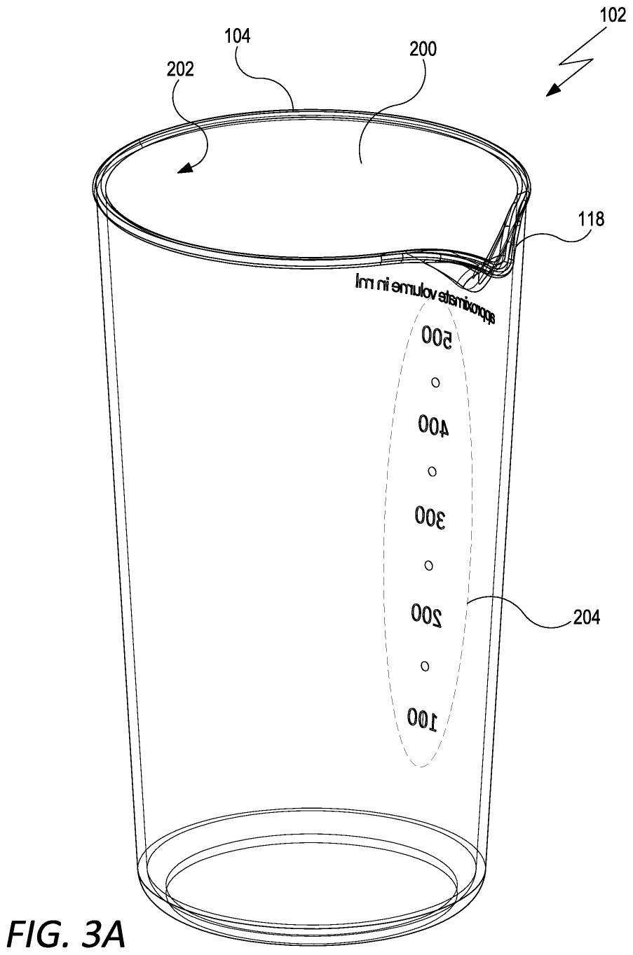

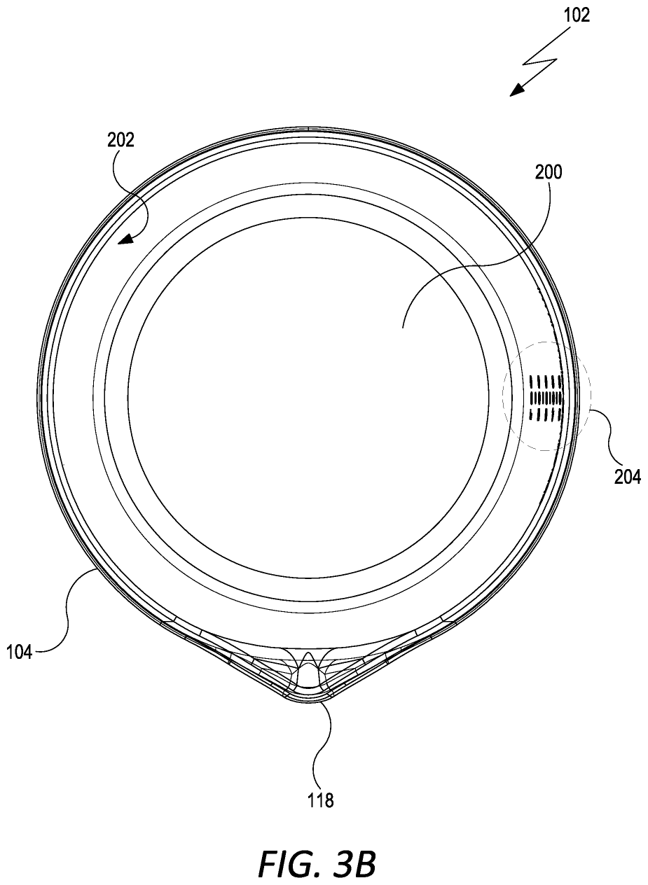

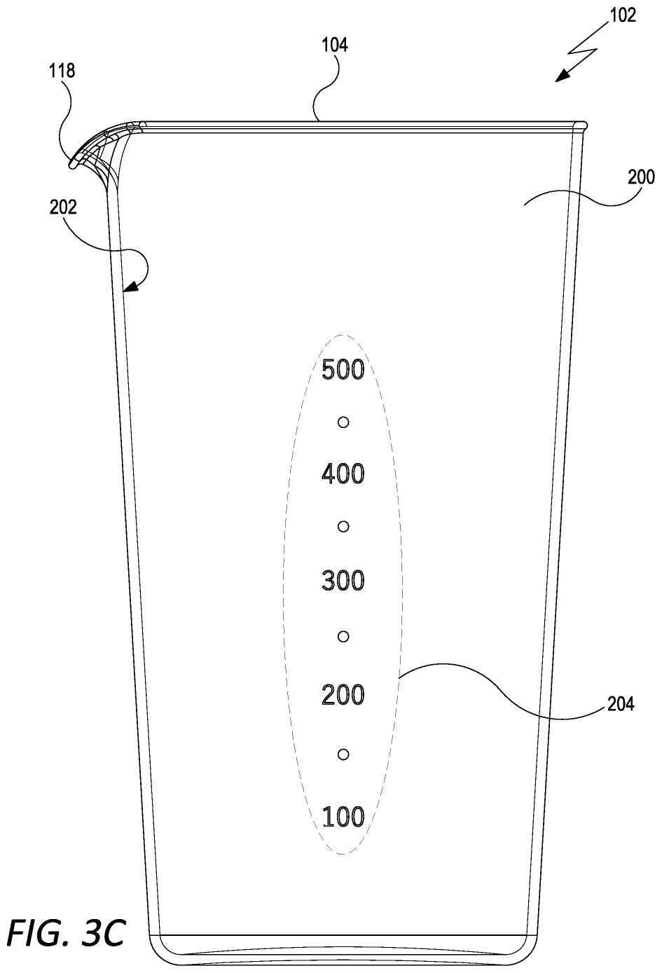

Turning to FIGS. 3A through 3B, various views of the brewing vessel 102 are shown in accordance with the present disclosure. In FIG. 3A a front-perspective view of the brewing vessel 102 is shown where the brewing vessel 102 is constructed with a transparent material that allows the volume markings 204 to be visible. FIG. 3B is a top view of the brewing vessel 102 and FIG. 3C is a side-view of the brewing vessel 102.

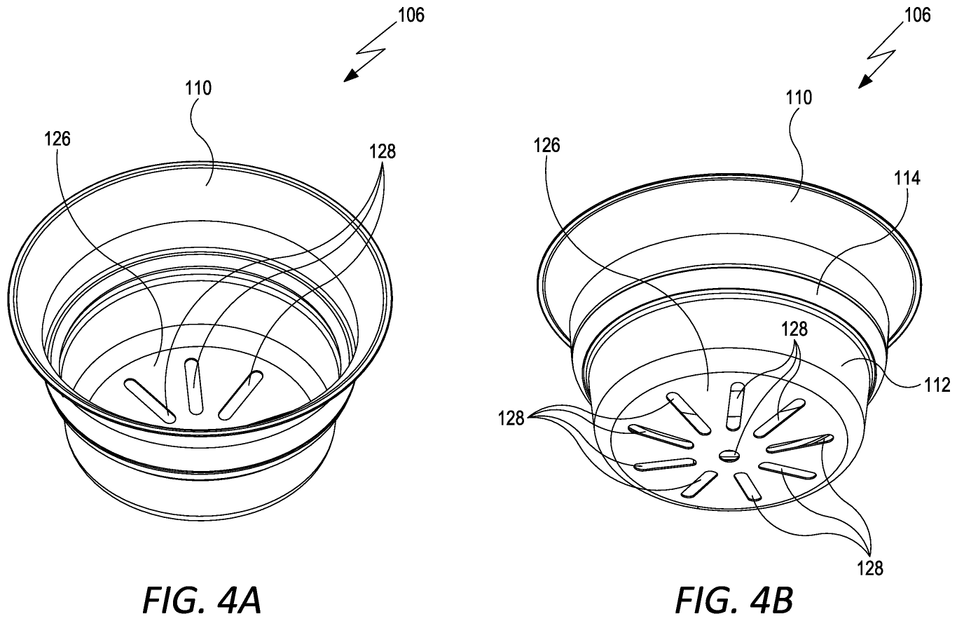

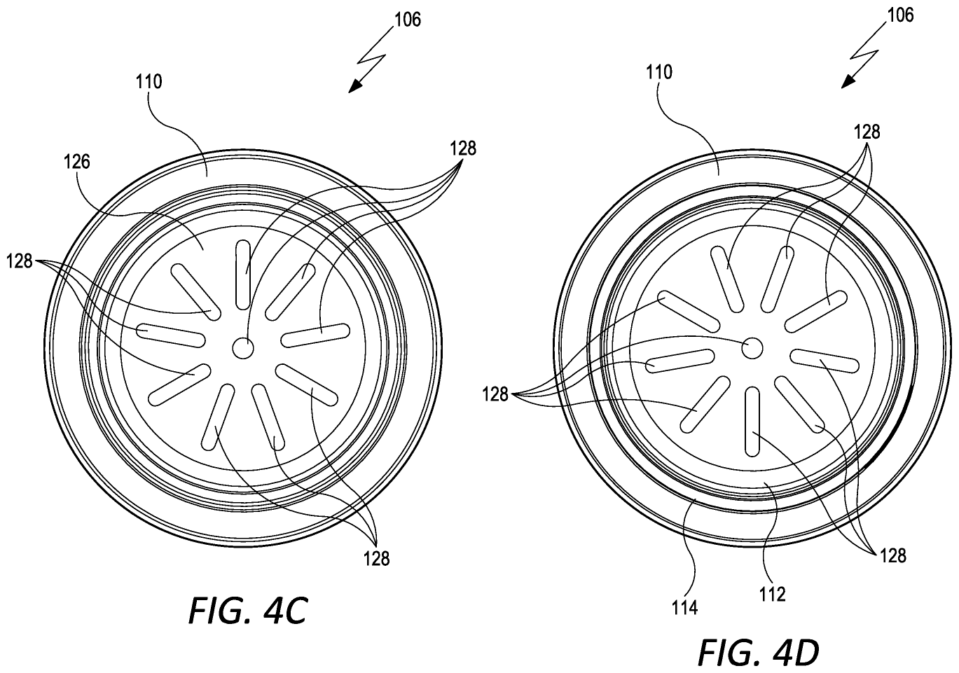

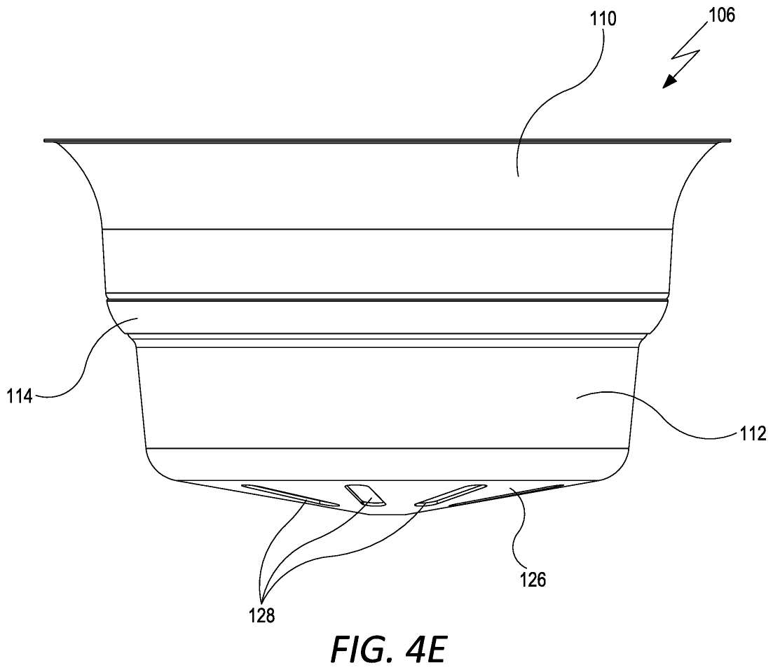

In FIGS. 4A through 4E, various views of the filter basket 106 are shown in accordance with the present disclosure. FIG. 4A is a top-perspective view of the filter basket 106 and FIG. 4B is bottom-perspective view of the filter basket 106. FIG. 4C is a top view of the filter basket 106 and FIG. 4D is a bottom view of the filter basket 106. FIG. 4E is a side-view of the filter basket 106.

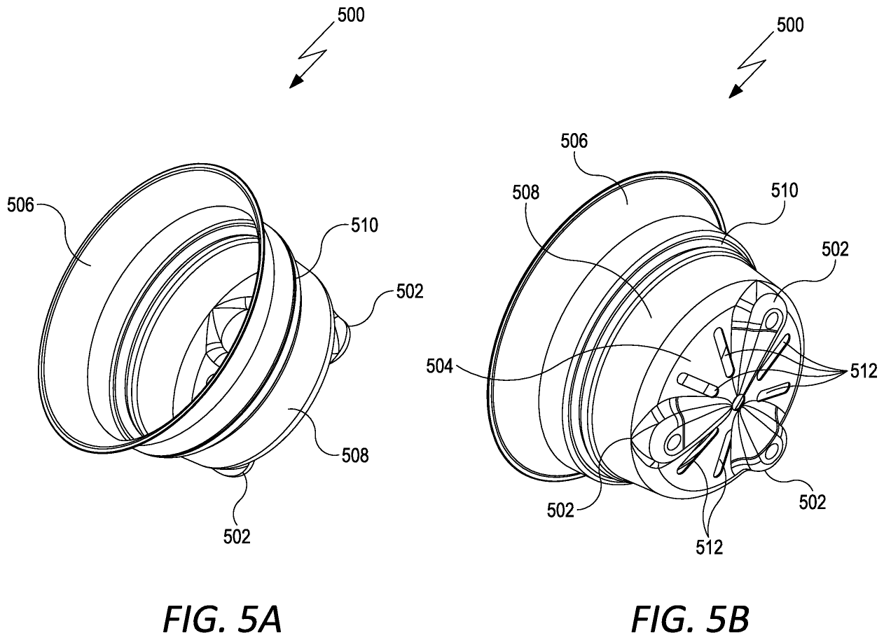

In FIGS. 5A and 5B an example of another implementation of the filter basket 500 is shown in accordance with the present disclosure. FIG. 5A is a top-perspective view of the filter basket 500 and FIG. 5B is a bottom perspective view of the filter basket 500. In this example, the new filter basket 500 is similar to the previous examples of the filter basket 106 described in FIGS. 1A through 4E, except that the filter basket 500 also includes a plurality of feet 502 at the bottom surface 504 of the filter basket 500. Similar to the examples of the filter basket 106 described in FIGS. 1A through 4E, the filter basket 500 includes a top portion 506, lower portion 508, a basket guard 510, and the bottom surface 504. Again, the filter basket 500 includes a plurality of draining holes 512 at the bottom surface 504.

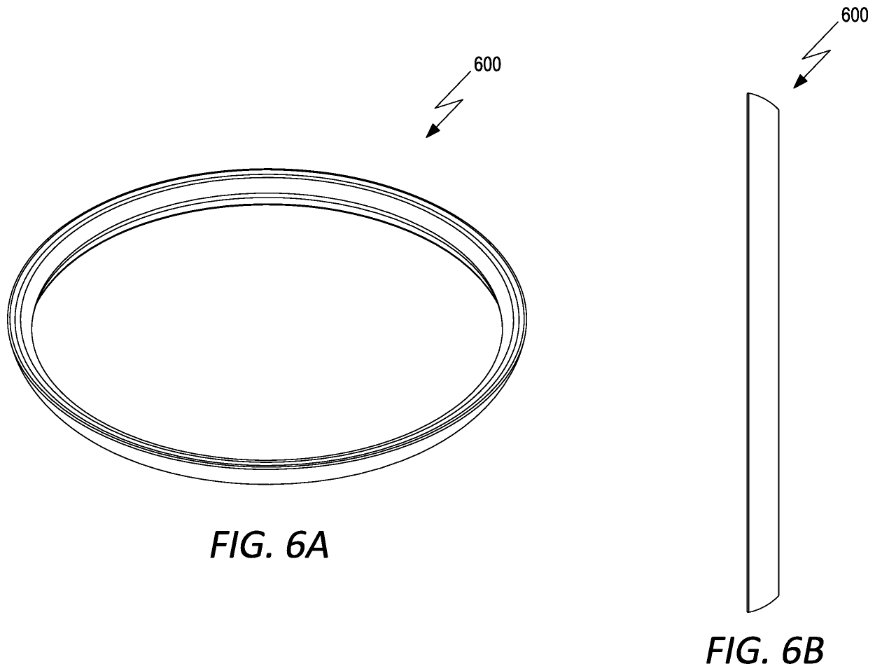

Turning to FIG. 6A, a top-perspective view of an example of an implementation of the basket guard 600 is shown in accordance with the present disclosure. In FIG. 6B, a side-view of the basket guard 600 is shown in accordance with the present disclosure. In this example, the basket guard 600 may be either the basket guard 114 shown in FIGS. 1A-4E or the basket guard 510 shown in FIGS. 5A and 5B. Again, the basket guard 114 may be a gasket constructed of rubber or silicone.

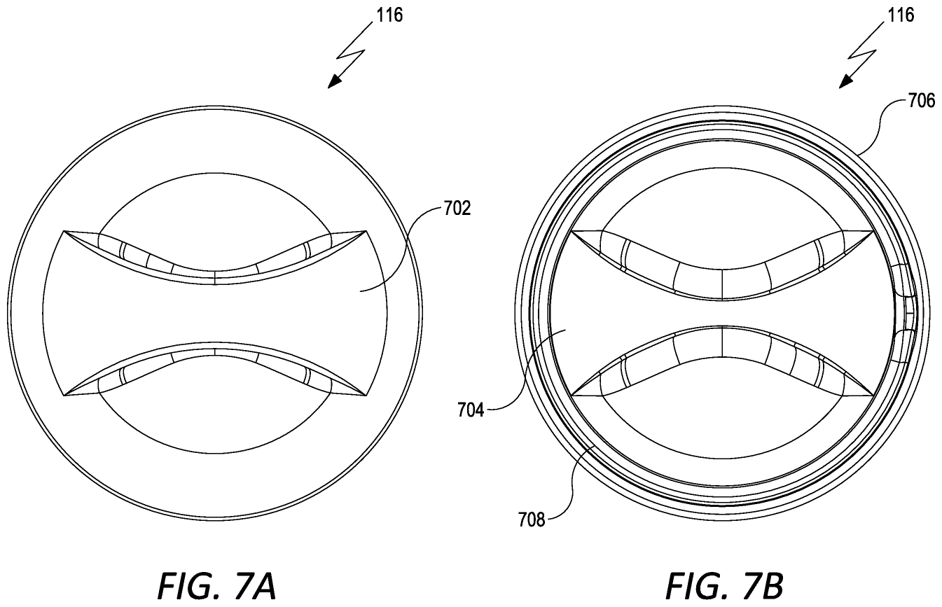

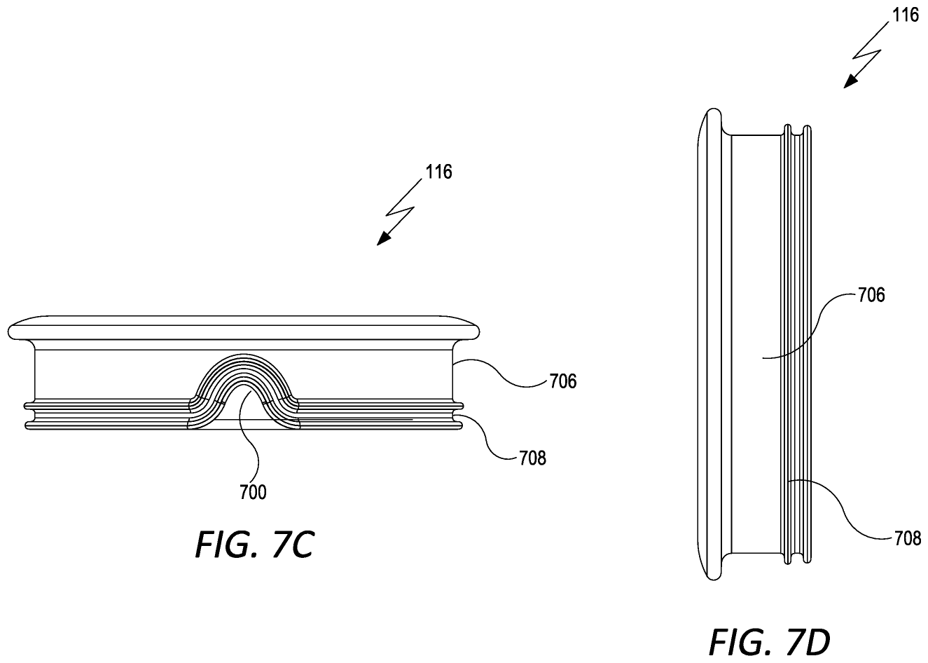

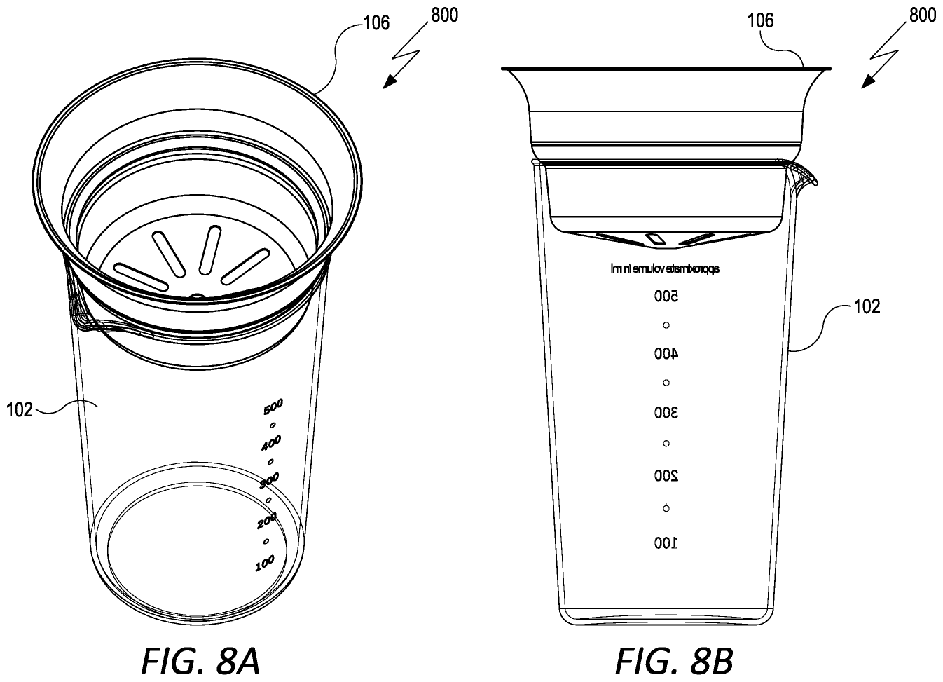

In FIGS. 7A through 7D, various views of the lid 116 are shown in accordance with the present disclosure. Specifically, FIG. 7A is a top view of an example of an implementation of the lid 116 in accordance with the present disclosure. FIG. 7B is a bottom view of the lid 116 and FIG. 7C is a front view of the lid 116 in accordance with the present disclosure. Moreover, FIG. 7D is a side-view of the lid 116 in accordance with the present disclosure.

The lid 116 may include an off-gassing opening 700 (i.e., vent) and a gripping section 702. The gripping section 702 is configured to allow for the lid 116 to be rotated from a sealed position that prevents off-gassing to an open position that allows off-gassing along the rim of the top 104 of the brewing vessel 102. The off-gassing is through the off-gassing opening 700. The lid 116 may also include a bottom portion 704 that is configured to allow the filter basket 106 to rest on the inside of the of the bottom portion 704 of the lid 116 to prevent spillage of the brewed coffee or tea. The lid 116 may also be constructed of rubber or silicone to fit tightly into the opening at the top 104 of the brewing vessel 102. The lid 116 may include a top-side portion 706 and a bottom-side portion 708 where the off-gassing opening 700 is within both the top-side portion 706 and a bottom-side portion 708 and the bottom-side portion 708 may include a soft gripping texture configured to grip the inner surface 202 of the cavity 200 of the brewing vessel 102.

Turning to FIG. 8A, a top-perspective view of an example of an implementation of a combination 800 of the brewing vessel 102 and filter basket 106 are shown in accordance with the present disclosure. FIG. 8B is a side-view of the brewing vessel 102 and filter basket 106 shown in FIG. 8A in accordance with the present disclosure.

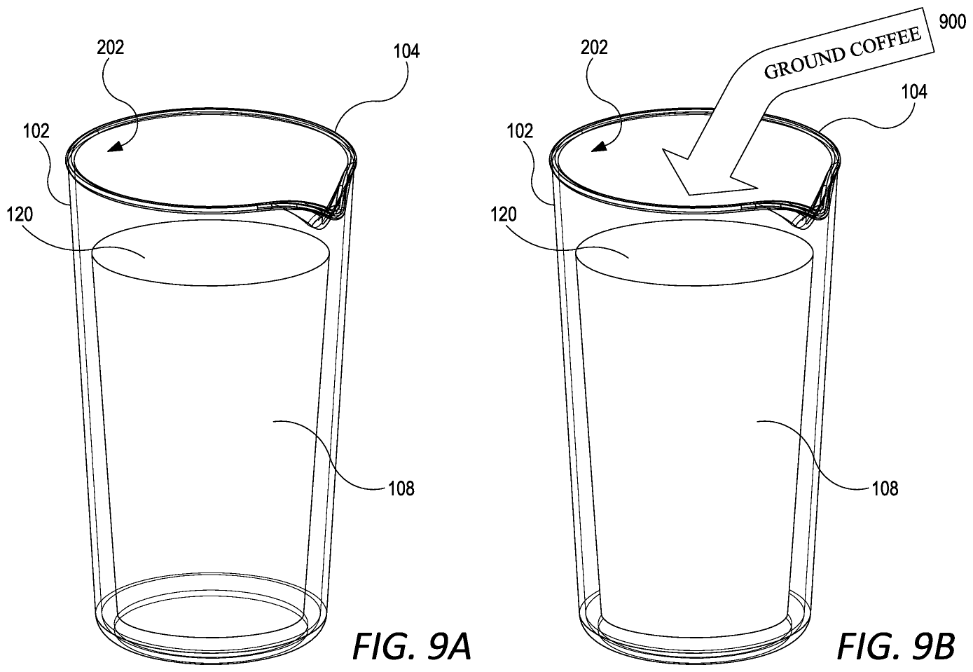

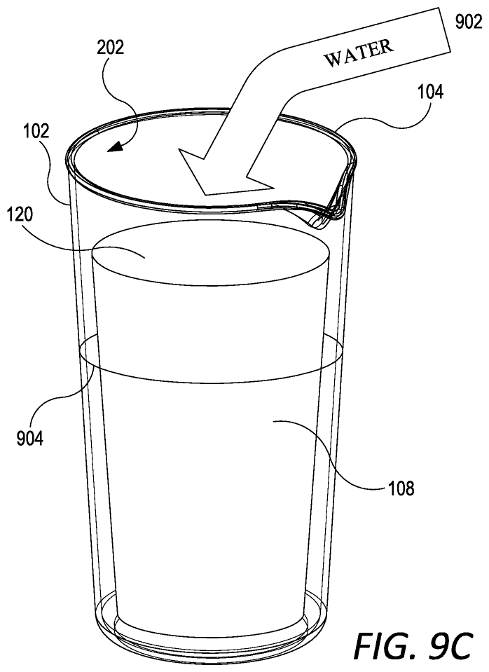

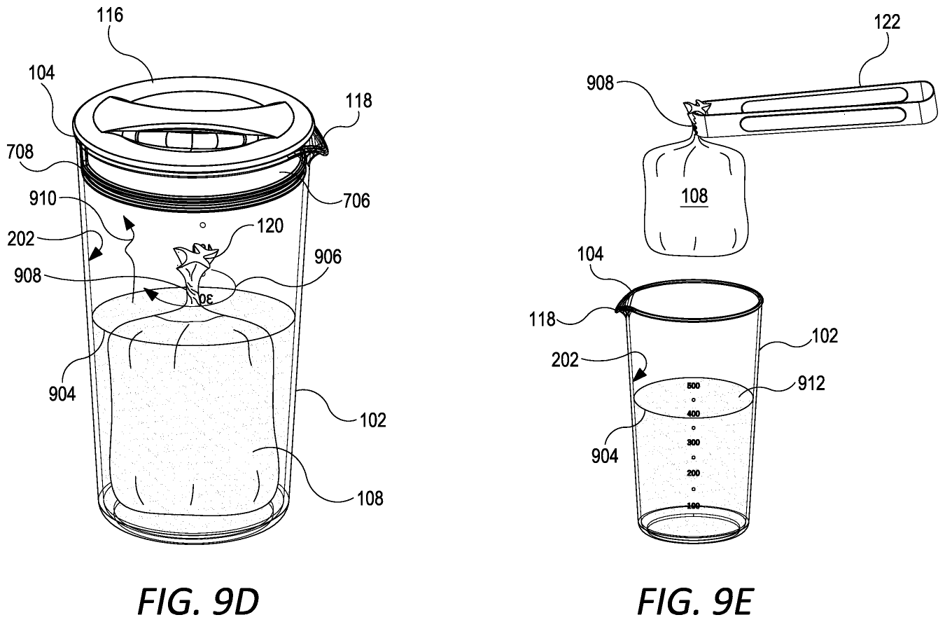

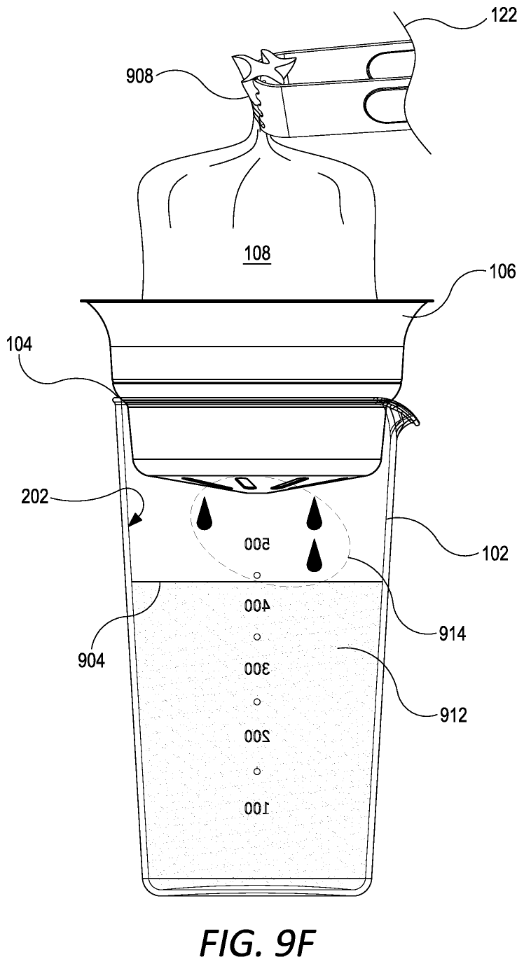

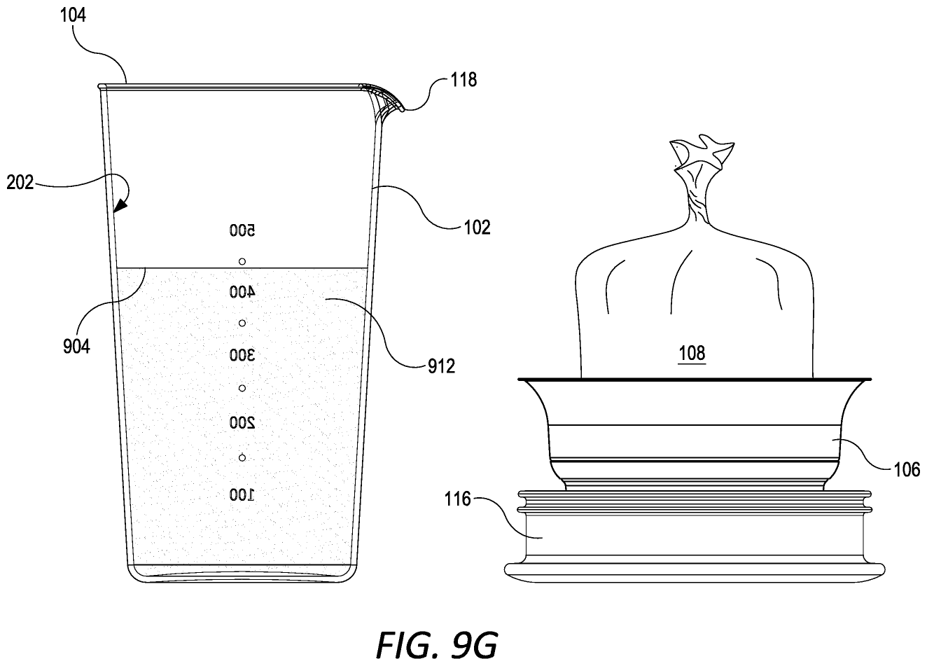

In FIGS. 9A through 9G, various steps are shown for immersion brewing of coffee or tea in accordance with the present disclosure. Specifically, in FIG. 9A, a side-perspective view of an example of an implementation of the brewing vessel 102 with a closeable filter 108 is shown in accordance with the present disclosure.

FIG. 9B is a side-perspective view of the brewing vessel 102 with the closeable filter 108 receiving ground coffee 900 and FIG. 9C is a side-perspective view of the brewing vessel 102 with the closeable filter 108 (having ground coffee 900) receiving water 902 in accordance with the present disclosure. In FIG. 9D, a side-perspective view of the brewing vessel 102 with the closeable filter 108 and lid 116 is shown in accordance with the present disclosure.

FIG. 9E is a side-perspective view of the brewing vessel 102 with the closeable filter 108 being removed and FIG. 9F is a side-view of the combination 800 of the brewing vessel 102 and filter basket 106 with the closeable filter 108 being placed within the filter basket 106 in accordance with the present disclosure. In FIG. 9G, a side-view of a combination of the brewing vessel 102 after the filter basket 106 and closeable filter 108 have been removed is shown in accordance with the present disclosure.

In this example, the closeable filter 108 is first inserted into cavity 200 of the brewing vessel 102 through the top 104 of the brewing vessel 102 in FIG. 9A. The closeable filter 108 is initially empty and then is filled with ground coffee 900 in FIG. 9B. The closeable filter 108 may be a form fit filter for optimal extraction and easy entry into/exit out of the brewing vessel 102. The closeable filter 108 may be part of a filter pack. In general, the closeable filter 108 may be large enough to fill the entire or large portion of the inside cavity 200 of the brewing vessel 102. In figures, the size of the filled closeable filter 108 is not to scale.

The closeable filter 108 is then filled with water 902 through the open top 120 of the closeable filter 108. The water 902 may be at ambient or colder than ambient temperature for cold brewing the ground coffee 900. However, the water 902 may also be optionally hot for slow brewing hot coffee. The water 902 may be poured on to the ground coffee 900 in the closeable filter 108 in a somewhat circular motion to help immerse the ground coffee 900. As the water 902 is poured in, the water will start to spread into the cavity 200 of the brewing vessel 102 through the pores of the closeable filter 108 so as to create a solution line 904 within the cavity 200 of the brewing vessel 102. Once the desired amount of water 902 has been added to the ground coffee 900, the open top 120 of the closeable filter 108 may be shut (i.e., somewhat sealed) by twisting 906 the open top 120 closed to form a neck 908 of the closeable filter 108. In FIG. 9D, the lid 116 is then be placed on the top 104 of the brewing vessel 102. Initially the lid 116 may be set to the sealed position that prevents off-gassing of the gasses 910 formed within the cavity 200 of the brewing vessel 102 while the ground coffee 900 brews within the cavity 200. The ground coffee 900 is then allowed to soak for a predetermined time that may be between approximately one to 24 hours in either an ambient or a refrigerated temperature. After the predetermined time, in FIG. 9E, the lid 116 is removed from the brewing vessel 102 and the closeable filter 108 is removed from the cavity 200 of the brewing vessel 102 leaving a brewed coffee concentrate 912 within the cavity 200 of the brewing vessel 102. In FIG. 9F, the filter basket 106 is placed on the top 104 of the brewing vessel 102 and the closeable filter 108 is placed within the filter basket 106 to allow any liquid within the closeable filter 108 to drain out and drip 914 into the cavity 200 of the brewing vessel 102. In FIG. 9G, the filter basket 106 and closeable filter 108 are removed and placed on the bottom portion 704 of the lid 116. The brewed coffee concentrate 912 is ready to serve via the spout 118. This process may be utilized for cold brewing coffee or tea or hot brewing based on the temperature of the water 902 used.

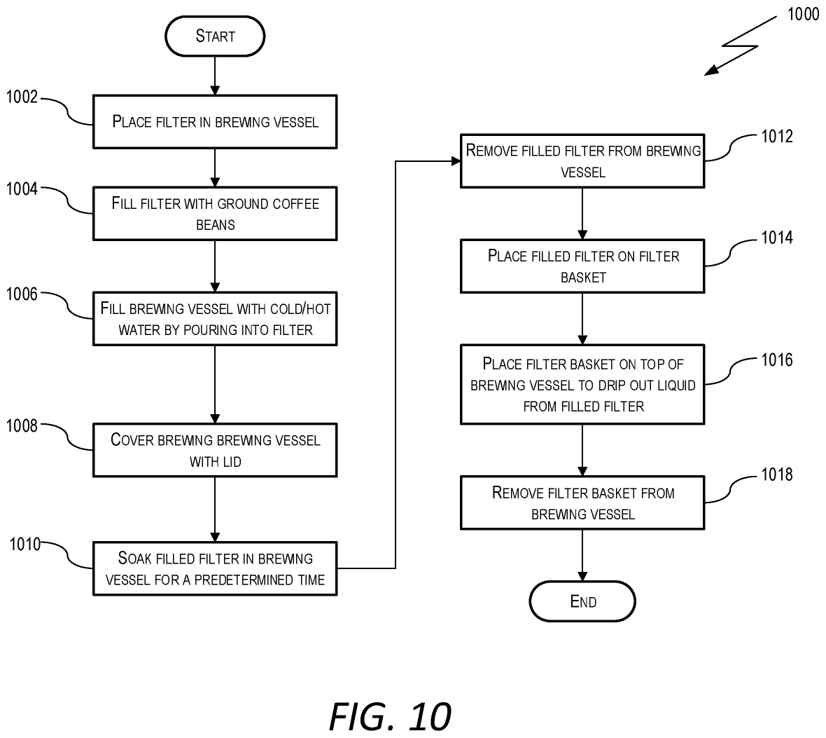

FIG. 10 is a flowchart of an example of an implementation of a general method for immersion coffee or tea brewing in accordance with the present disclosure. In this example, the method 1000 generally includes placing 1002 the closeable filter 108 in the brewing vessel 102, filing 1004 the filter 103 with ground coffee 900 beans to form a filled closeable filter 108, filling 1006 the brewing vessel 102 with water by pouring the water 902 into the filled closeable filter 108, closing the filled closeable filter 108 by twisting shut the open top 120 of the closeable filter 108, and covering 1008 the top 104 of the brewing vessel 102 with the lid 116. The method 1000 then includes soaking 1010 the filed closeable filter 108 in the brewing vessel 102 for a predetermined time; removing 1012 the filed closeable filter 108 from the brewing vessel 102; placing 1014 the filed closeable filter 108 in the filter basket 106; placing 1016 the filter basket 106 on the top 104 of the brewing vessel 102; dripping 914 the coffee solution (i.e., the brewed coffee) from the filed closeable filter 108 into the brewing vessel 102; and removing 1018 the filter basket 106 from the brewing vessel 102 to allow the brewed coffee concentrate 912 in the brewing vessel 102 to be removed. The method 1000 then ends.

In this example, the predetermined time may be between approximately one to 24 hours or more. In this example, instead of twisting, the closeable filter 108 may also be closed by an optional built in drawstring or by tying closed with a string or clamping with a silicone clamp. Also, optionally, instead of closing, the closeable filter 108 may be left mostly open. In all of these examples, the closeable filter 108 is defined as partially sealed. Furthermore, while this example describes brewing coffee to produce a brewed coffee concentrate 912, the method 1000 may also be utilized to brew tea to produce a brewed tea concentrate.

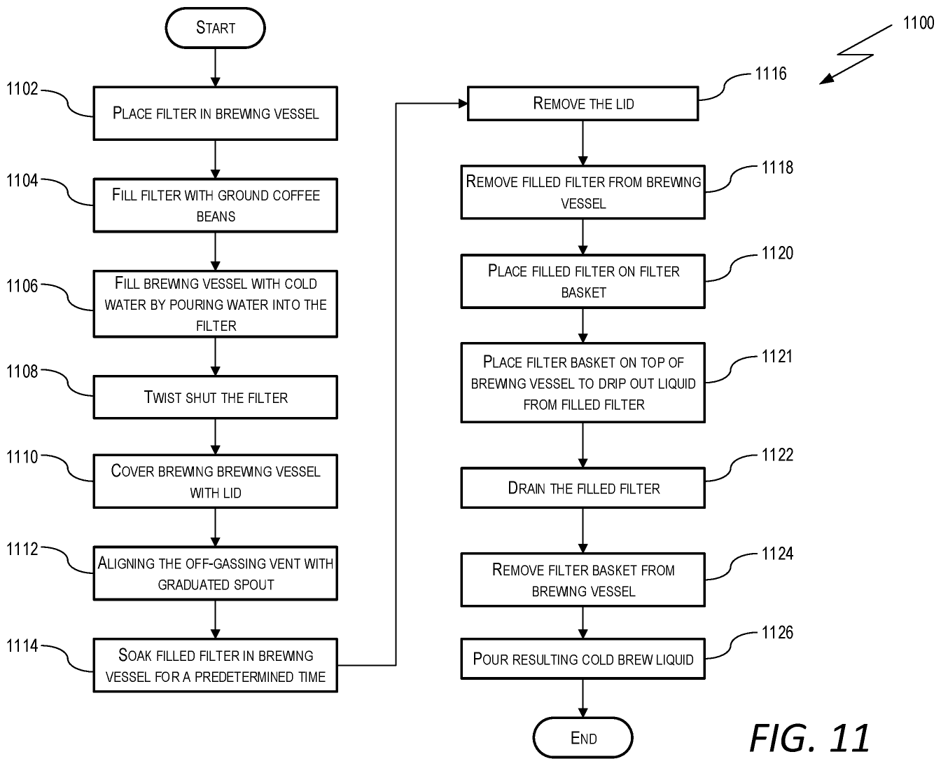

FIG. 11 is a flowchart of an example of an implementation of a specific method for cupping a cold brew coffee in accordance with the present disclosure. In this example, the method 1100 includes opening the closeable filter 108 and placing 1102 the closeable filter 108 in the brewing vessel 102 and pouring ground coffee 900 into the closeable filter 108 to fill 1104 the closeable filter 108. Filing 1106 the brewing vessel 102 by pouring ambient or cold water 902 into the closeable filter 108 over the ground coffee 900 while the closeable filter 108 is open, twisting shut 1108 the open top 120 of the closeable filter 108 to close the closeable filter 108 and produce the filled closeable filter 108 of ground coffee 900 beans, covering 1110 the top 104 of the brewing vessel 102 with the lid 116, aligning 1112 the off-gassing opening 700 of the lid 116 with the graduated spout 118. The method 1100 then allows the ground coffee beans in the filled closeable filter 108 to soak 1114 for a predetermined time that may be between approximately one to 24 hours or more. Again, in this example, instead of twisting, the closeable filter 108 may also be closed by an optional built in drawstring or by tying closed with a string or clamping with a silicone clamp. Also, optionally, instead of closing, the closeable filter 108 may be left mostly open. In all of these examples, the closeable filter 108 is defined as partially sealed.

After the predetermined time, the method 1100 then includes removing 1116 the lid 116 from the brewing vessel 102 and removing 1118 the filled closeable filter 108 from the brewing vessel 102. The filled closeable filter 108 may be removed 1118 from the brewing vessel 102 with the tongs 122. The filled closeable filter 108 is then placed 1120 on top of the filter basket 106 where the filter basket 106 has been placed 1121 on top of the brewing vessel 102. In these example steps, it is appreciated by those of ordinary skill in the art that the filter basket 106 may be placed on the top of the brewing vessel 102 before the filled closeable filter 108 is placed on top of the filter basket 106. The method 1100 then includes draining 1122 the filled closeable filter 108 into the brewing vessel 102, removing 1124 the filter basket 106 from the brewing vessel 102 and disposing the filled closeable filter 108, and pouring 1126 the resulting cold brew coffee concentrate 912 liquid out of the brewing vessel 102 and into a bowl for sensory analysis. The method 1100 then ends. Again, while this example describes brewing coffee to produce the brewed coffee concentrate 912, the method 1100 may also be utilized to brew tea to produce a brewed tea concentrate.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as example implementations of such techniques.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. An immersion coffee or tea brewing (ICB) system, the ICB system comprising:
a brewing vessel having a top, wherein the brewing vessel is configured to receive a closeable filter having coffee or tea within the brewing vessel and water; and
a filter basket configured to
be removably attached to the top of the brewing vessel,
hold the closeable filter, and
drain the closeable filter into the brewing vessel.

2. The ICB system of claim 1, further including a lid configured to
be removably attached to the top of the brewing vessel prior to removably attaching the filter basket, and
seal the brewing vessel for storage or to prevent off-gassing from the immersion of the coffee or tea in the water.

3. The ICB system of claim 2, wherein
the lid includes an off-gassing opening, and
the lid is configured to be rotated along the top of the brewing vessel from a sealed position for storage or that prevents off-gassing to an open position that allows off-gassing or serving through the off-gassing opening.

4. The ICB system of claim 3, wherein the brewing vessel includes a spout at the top of the brewing vessel and the spout is configured to allow off-gassing when the lid is rotated to the open position and the off-gassing opening of the lid is positioned adjacent the spout of the brewing vessel.

5. The ICB system of claim 1, wherein the brewing vessel is constructed of a transparent material.

6. The ICB system of claim 5, wherein the brewing vessel includes volume measurement markings along an outer surface of the brewing vessel.

7. The ICB system of claim 5, wherein the transparent material is glass.

8. The ICB system of claim 1, further including the closeable filter, wherein the closeable filter is a filter bag having an open top configured to receive the coffee or tea and the water.

9. The ICB system of claim 8, wherein the closeable filter is
further configured to be partially sealed by twisting the open top to a closed position after receiving the coffee or tea and water and
constructed from a material that allows the closeable filter to be steeped in a coffee solution or tea solution for an extended period of time, lifted from the brewing vessel after being filled with coffee or tea and immersed in the coffee solution or tea solution for the extended period of time, and placed on the filter basket to drain the coffee solution or tea solution from the closeable filter to the brewing vessel, and
wherein the coffee solution is created by the coffee and the water and the tea solution is created by the tea and water.

10. The ICB system of claim 9, wherein the extended period of time is greater than approximately one hour.

11. The ICB system of claim 1, wherein the filter basket includes draining holes at a bottom of the filter basket.

12. A method for immersion coffee or tea brewing, the method comprising:
inserting a closeable filter into a brewing vessel having a top;
inserting coffee or tea into the closeable filter;
pouring water into the closeable filter;
partially sealing the closeable filter;
steeping the closeable filter within the water in the brewing vessel for an extended period of time;
removing the closeable filter from the brewing vessel; and
draining the closeable filter into the brewing vessel.

13. The method of claim 12, further including removably attaching a filter basket on the top of the brewing vessel, wherein draining the closeable filter includes placing the closeable filter on the filter basket.

14. The method of claim 13, further including
removably attaching a lid to the top of the brewing vessel prior to removing the closeable filter and
sealing the brewing vessel with the lid for storage or to prevent off-gassing from the immersion of the coffee or tea in the water.

15. The method of claim 14, further including rotating the lid along the top of the brewing vessel from a seal position for storage or that prevents off-gassing to an open position that allows serving or off-gassing through an off-gassing opening within the lid.

16. The method of claim 13, wherein the extended period of time is greater than one hour.

17. The method of claim 13, wherein partially sealing the closeable filter includes twisting an open top of the closeable filter to a closed position.

18. The method of claim 13, wherein pouring water into the closeable filter includes pouring water that is at ambient temperature.

19. The method of claim 18, wherein steeping the closeable filter within the water includes steeping the closeable filter within the water in an environment that is at a temperature that is below ambient.

20. The method of claim 12, wherein inserting coffee includes pouring coffee grounds into the closeable filter.
